(19) United States
(12) Patent Application Publication
(10) Pub. No.: US 2007/0243902 A1
(43) Pub. Date: Oct. 18, 2007

(54) Configuration containing at least two radio sections and method for operating the configuration

(75) Inventors: Lutz Puschel, Berlin (DE); Jorg Tielmann, Berlin (DE)

Correspondence Address: LERNER GREENBERG STEMER LLP, P O BOX 2480, HOLLYWOOD, FL, 33022-2480, US

(73) Assignee: Aastra DeTeWe GmbH

(21) Appl. No.: 11/786,806

(22) Filed: Apr. 13, 2007

(30) Foreign Application Priority Data
Apr. 13, 2006 (EP) 06 007 768.2

(51) Int. Cl. H04B 1/38; H04M 1/00

(52) U.S. Cl. 455/560

(57) ABSTRACT

A configuration contains at least two radio sections. Each radio section in each case has a line-connected network segment and one or more radio network access devices connected thereto in a line-connected manner. In each case mobile radio terminals can be connected by radio, and the network segments of the at least two radio sections are connected to a connecting device which connects the two network segments with one another. A control device is constructed in such a manner that, as soon as one of the mobile radio terminals changes from one of the radio sections to another one of the radio sections, it automatically reparameterizes the transmission characteristics at least at one point or in one section of the transmission paths available to the mobile radio terminal which has changed the radio section.

### CROSS-REFERENCE TO RELATED APPLIC ION

This application claims the priority, under 35 U.S.C. §119, of European application EP 06 007 768.2, filed Apr. 13, 2006; the prior application is herewith incorporated by reference in its entirety.

### BACKGTROUND OF THE INVENTION

1. Field of the Invention

The invention relates to a configuration having at least two radio sections. Wherein each radio section in each case has a line-connected network segment and one or more radio network access devices connected thereto in a line-connected manner, to which in each case at least one mobile radio terminal can be connected by radio. The network segments of the at least two radio sections are connected to a connecting device which connects the two network segments with one another. In this connection, the term network segment is understood to be an independent separate network having homogeneous uniform transmission characteristics or a section of a complex higher-level network having homogenous uniform transmission characteristics within the section.

In the field of mobile radio technology, for example, a configuration containing at least two radio sections are known in which each radio section has in each case a line-connected network segment and one or more radio network access devices—such as, for example, base stations—which are connected thereto in a line-connected manner. To each radio network access device, one or more mobile radio terminals can be connected, in turn, by radio. The network segments of the radio sections are connected to one another, for example, by a connecting device in order to provide for communication between the network segments and thus for communication between the radio sections.

### SUMMARY OF THE INVENTION

It is accordingly an object of the invention to provide a configuration containing at least two radio sections and a method for operating the configuration which overcome the above-mentioned disadvantages of the prior art methods and devices of this general type. The invention is based on the object of improving the configuration, in such a manner that problems during a change of radio section of a mobile radio terminal from one radio section to another radio section are avoided and the most optimum possible transmission characteristic is ensured also in the case of such a change of radio section.

With the foregoing and other objects in view there is provided, in accordance with the invention, a configuration containing at least two radio sections. Each one of the radio sections has a line-connected network segment and at least one radio network access device connected in a line-connected manner to the network segment. The at least one radio network access device is provided for connecting by radio to at least one mobile radio terminal. A connecting device is connected to the network segment of each of the at least two radio sections for connecting the two network segments with one another. A control device is constructed such that, as soon as the mobile radio terminal changes from one of the radio sections to another one of the radio sections, the control device automatically reparameterizes transmission characteristics at least at one point or in one section of transmission paths available to the mobile radio terminal which has changed to a different one of the radio sections.

According to the invention, the object is achieved by the fact that the configuration has a control device which is constructed in such a manner that, as soon as one of the mobile radio terminals changes from one of the radio sections to another one of the radio sections, it automatically performs a reparameterization of the transmission characteristics at least at one point or at least in one section of the transmission paths which are available to the mobile radio terminal which has changed the radio section. A point of a transmission path available to the mobile radio terminal can be formed, for example, by a network node (e.g. radio network access device, router, bridge, etc.) of the network segment of the new radio section; a section of a transmission path available to the mobile radio terminal can be formed, for example, by a transmission section between two immediately adjacent or indirectly adjacent network nodes (e.g. radio network access device, router, bridge, etc.) of the network segment of the new radio section.

An advantage of the configuration according to the invention can be seen in the fact that, in the case of a change of radio section, the control device provided according to the invention performs an automatic adaptation to the new transmission situation by performing a corresponding reparameterization of the transmission characteristics. This will be explained in greater detail hereinafter by an example: if, for example, a mobile radio terminal is located in a radio section, the associated network segment of which is very efficient, the mobile radio terminal can utilize correspondingly high transmission capacity, for example by utilizing a high transmission rate. If the mobile radio terminal then moves into another radio section in which increasingly less great transmission capacities are available, for whatever reasons, translation disturbances or interruptions may occur. This is where the invention comes into play in that, according to the invention, a control device is provided which recognizes a radio section change and performs an automatic reparameterization of the transmission characteristics.

Depending on the transmission situation, an adequate reparameterization may be achieved already if the transmission characteristics are reparameterized at a single point or in a single section of the transmission paths available to the mobile radio terminal overall. Such a case may occur, for example, if only a single point or a single section could lead to transmission problems.

If, for example, a “transmission bottleneck” is due to limited transmission capabilities between the new network segment and the connecting device connected to it, it is considered to be advantageous if the control device reparameterizes the transmission characteristics at least at one point or in one section of the connecting paths between the mobile radio terminal which has changed the radio section and the connecting device.

If, for example, a “bottleneck” is due to the lower efficiency of the entire new network segment, it is considered to be advantageous if the control device reparameterizes the transmission characteristics in each case for each transmission path available in the new network segment for the mobile radio terminal which has changed the radio section. Such reparameterization can take place, for example, in that the transmission characteristics are reparameterized in each case at least at one point or in one section for each transmission path.

As already mentioned, the configuration can be operated reliably due to the control device even if the line-connected network segments of the at least two radio sections have different transmission characteristics. This correspondingly applies if the line-connected network segments of the radio sections have identical transmission characteristics and only the transmission characteristics of the connecting device differ from those of the two network segments.

The transmission characteristics can differ, for example, with respect to the bandwidths, the packet delay times, the packet loss rates and/or jitter.

The control device will perform the reparameterization of the transmission characteristics preferably with the aim of achieving a predetermined minimum transmission quality (quality of service) for the mobile radio terminal which has changed the radio section.

The network segments can be, for example, LAN networks, preferably those which transmit or at least can transmit IP (Internet compatible) data packets.

The control device can perform the reparameterization of the transmission characteristics, for example, by changing the degree of compression of the data to be transmitted, the priority of the data packets to be transmitted and/or the packet size of the data packets to be transmitted. These or other changes can be performed in individual, several or all network nodes (e.g. rotors, bridge, etc.) of the network segments, individual or all communication components of the connecting device individual or all radio network access devices and/or individual or all mobile radio terminals.

The radio network access devices are preferably WLAN access points and the mobile radio terminals are preferably WLAN terminals. The radio network access devices can just as well be DECT base stations and the mobile radio terminals can be DECT mobile parts.

For example, the control device performs the reparameterization of the transmission characteristics in that it also or exclusively reparameterizes the mobile radio terminal. Such reparameterization can be performed, for example, in WLAN terminals in that the WLAN terminal is provided with new transmission parameters such as data packet sizes, degrees of compression, CODEC, etc. which are to be converted by the WLAN terminal.

As an alternative or additionally, the control device can perform the reparameterization of the transmission characteristics in that it also or exclusively reparameterizes the radio network access device to which the mobile radio terminal has changed. Such reparameterization can be performed, for example, in DECT base stations in that the DECT base station is provided with new transmission parameters such as data packet sizes, degree of compression, CODEC, etc. which are to be converted by the DECT base station.

Particularly preferably, the control device will parameterize the transmission characteristics across radio sections in such a manner that all transmission paths are taken into consideration which can be accessed by the mobile radio terminal which has changed a radio section, newly enter the radio section or has been newly switched on or registered in it. In this context, the control device will preferably perform the parameterization in such a manner that data or voice transmission can take place even over the transmission path with the lowest power (e.g. because of little bandwidth, large jitter, high packet losses) with a predetermined minimum quality standard (qualify of service).

The invention is also related to a method for operating a configuration as has been described initially.

To avoid problems during a radio section change of mobile radio terminals in such a method and ensure the most optimum possible transmission characteristic even in the case of such a radio section change, it is proposed according to the invention that it is determined when one of the mobile radio terminals changes from one of the radio sections to another radio section and that in such a case, a reparameterization of the transmission characteristics is carried out at least at one point or in one section of the transmission paths available to the mobile radio terminal which has changed the radio section.

With respect to the advantages of the method according to the invention, reference is made to the above statements in connection with the configuration according to the invention since the advantages of the method correspond to the advantages of the configuration.

Other features which are considered as characteristic for the invention are set forth in the appended claims.

Although the invention is illustrated and described herein as embodied in a configuration containing at least two radio sections and a method for operating the configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of a first exemplary embodiment of a configuration according to the invention in which a control device is connected to a connecting device;

FIG. 2 is a block circuit diagram of a second exemplary embodiment of the configuration according to the invention in which the control device is integrated within a switching device of the configuration;

FIG. 3 is a block circuit diagram of a third exemplary embodiment of the configuration according to the invention in which the control device is connected to a network segment of a radio section; and

FIG. 4 is a block circuit diagram of a fourth exemplary embodiment of the configuration according to the invention in which the control device is integrated within a radio network access device of one of the radio sections.

### DESCRIPTION OF THE PREFERRED EMBODIMENTS

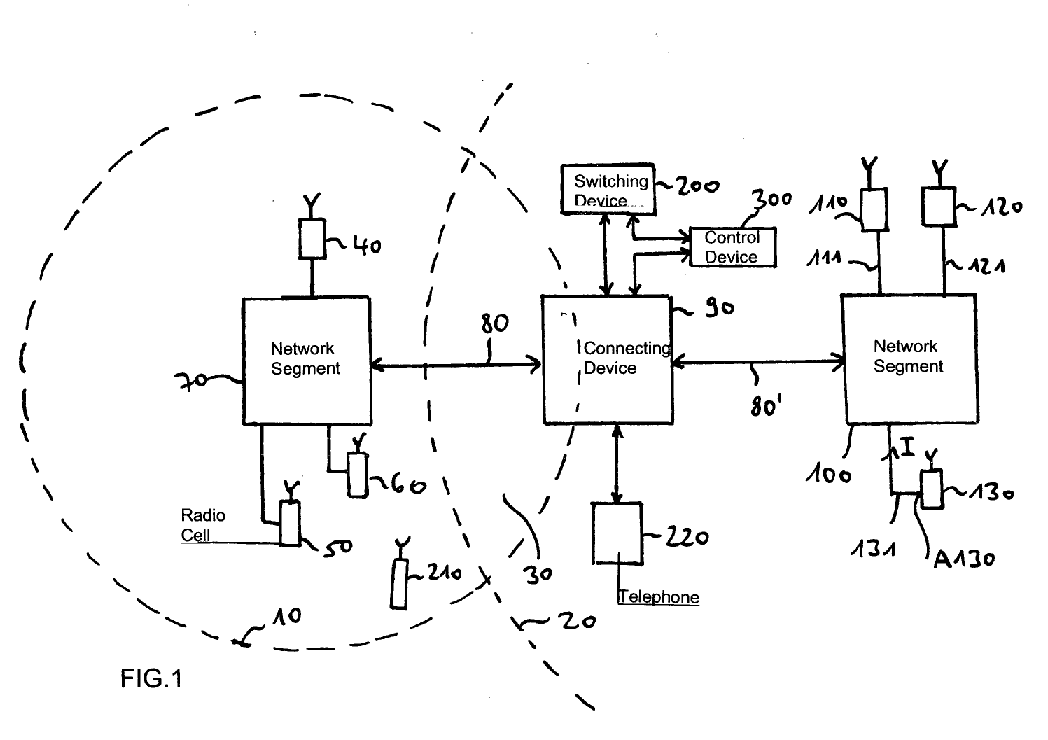

For the sake of clarity, the same reference symbols are used for identical or comparable components in the figures of the drawing. Referring now to the figures of the drawing in detail and first, particularly, to FIG. 1 thereof, there is shown two radio sections 10 and 20 which partially overlap. An area of overlap is identified by the reference symbol 30.

The radio section 10 is formed by a total of three radio cells which are produced by three radio network access devices. The three radio network access devices of the radio section 10 are marked by reference symbols 40, 50 and 60 in FIG. 1; the radio cells 40, 50, 60 themselves are not drawn in greater detail.

As can be seen additionally in FIG. 1, the three radio network access devices 40, 50 and 60 are in each case connected to a line-connected network segment 70 which can be, for example, a packet-oriented network. The network segment 70 transmits, for example data packets in Internet-compatible format. The network segment 70 can be, for example, a LAN network which operates e.g. in the Ethernet standard.

The network segment 70 of the radio section 10 is connected by a connecting line 80 to a connecting device 90 which connects the network segment 70 of the radio section 10 to a network segment 100 of the radio section 20 via a further connecting line 80′.

The radio section 20 is also formed, for example, by three radio cells which are produced by three radio network access devices 110, 120 and 130. The three radio network access devices are connected to the network segment 100 of the radio section 20 via corresponding connecting lines 111, 121 and 131. The network segment 100 can also be, for example, a packet-oriented network which transmits data packets according to the Internet standard.

FIG. 1 also shows that the connecting device 90 is connected to a switching device 200 which, for example organizes a voice and data transmission between mobile radio terminals, one of which is identified, for example, by the reference symbol 210 in FIG. 1, which are connected to the radio sections 10 and 20 and other telecommunication terminals connected to the connecting device 90. Such a telecommunication terminal can be formed, for example, by a cord-connected, e.g. analog telephone which is identified by the reference symbol 220 in FIG. 1.

FIG. 1 also shows a control device 300 which is connected to the connecting device 90 and to the switching device 200. The control device 300 has the task of reparameterizing the transmission characteristics as soon as the mobile radio terminal 210 changes to a different radio section 10, 20. This will be explained in greater detail in the text which follows by an example in which it is assumed that the mobile radio terminal 210 located in the radio section 10 changes into the radio section 20 and sets up a connection to the radio network access device 130.

As soon as the mobile radio terminal 210 is registered with the radio network access device 130, the latter provides at its output A130 corresponding information I that the mobile radio terminal 210 is now registered in the radio network access device 130. The information I passes via the network segment 100 and via the further connecting line 80′ to the control device 300 which processes the information I further. In real terms, the control device 300 is constructed in such a manner that, after a radio section change of one of the mobile radio terminals 210, it checks whether the transmission paths available to the changing mobile radio terminal 210 are correctly parameterized. The control device 300 operates correspondingly when a mobile radio terminal, for example the mobile radio terminal 210, is newly registered in the radio section 20.

This is because, in concrete terms, the problem may occur that the mobile radio terminal 210 had available other transmission resources, for example very large ones, in its original radio section 10 which are no longer available in the new radio section 20 or in the new network segment 100, respectively. To ensure, nevertheless, that the mobile radio terminal 210 can transmit or receive voice or data signals without interference in the radio section 20 or with the aid of the network segment 100, the transmission characteristics of the mobile radio terminal 210 and/or the transmission characteristics of the transmission paths available to the mobile radio terminal 210 must thus be correspondingly adapted.

Using, for example, records stored in a database which relate to the transmission capabilities of the two network segments 70 and 100, of the connecting device 90 and of the two connecting lines 80 and 80′, the control device 300 now checks whether reparameterization of the transmission characteristics relating to the mobile radio terminal 210 is required. If this is the case, the control device 300 transmits the corresponding new parameterization information via the connecting device 90 and the other connecting line 80′ to all components which must be reparameterized with regard to interference-free transmission.

For example, the control device 300 transmits a new set of parameters to the radio network access device 130 which is connected to the mobile radio terminal 210. As an alternative, the control device 300 can also transmit a new set of parameters directly to the mobile radio terminal 210 so that the latter uses, for example, another CODEC and performs higher compression of data and, associated with this, utilizes less bandwidth in order to reduce the resources needed by the mobile radio terminal 210.

As an alternative, the control device 300 can also initially contact the switching device 200 in order to request from it a new set of parameters for operating the mobile radio terminal 210 or the radio network access device 130 after a radio section change of the mobile radio terminal 210. For example, the switching device 200 in this case transmits Codec information to the control device 300 so that the latter can forward the corresponding Codec information to the radio network access device 130 and/or to the mobile radio terminal 210 connected to it.

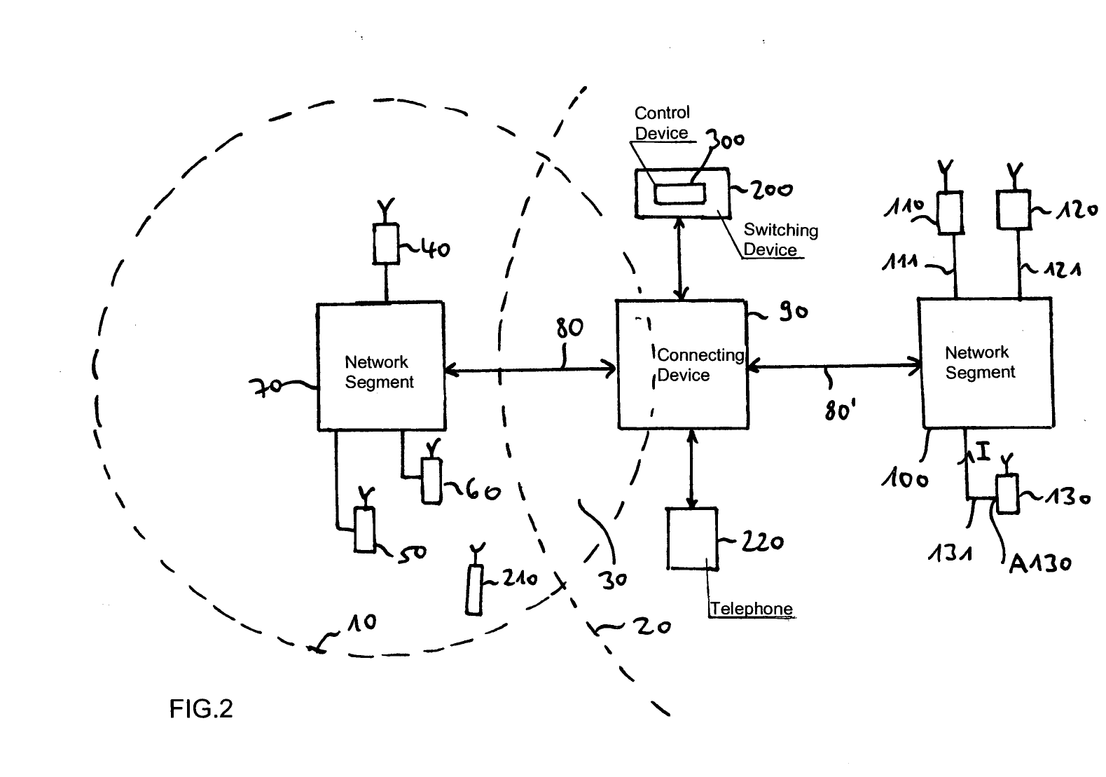

In the exemplary embodiment according to FIG. 1, the control device 300 is a separate component which is connected to the connecting device 90 and to the switching device 200. As an alternative, the control device 300 can also be a component of the switching device 200. Such an exemplary embodiment is shown in FIG. 2. The operation of the control device 300 preferably corresponds to that which has been explained in conjunction with FIG. 1.

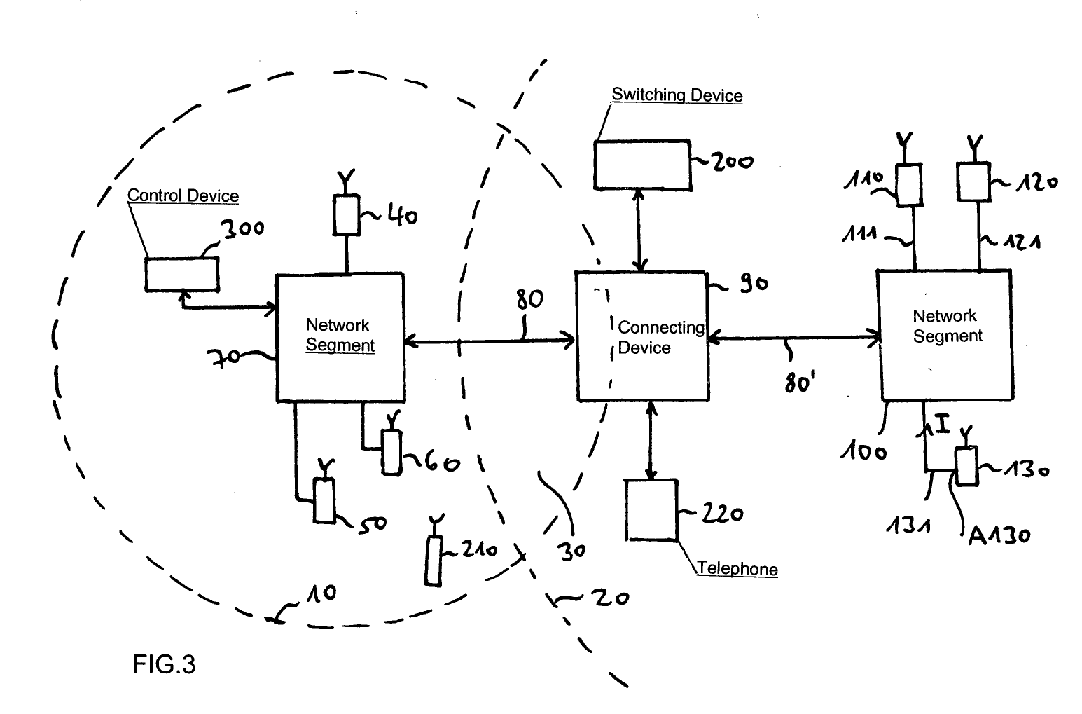

FIG. 3 shows a further exemplary embodiment of the allocation of the control device 300. In this exemplary embodiment, the control device 300 is not connected to the connecting device 90 but to one of the network segments of the radio sections, for example to the network segment 70 of radio section 10. In this exemplary embodiment, too, the control device 300 can perform a reparameterization of individual or all transmission paths available to the mobile radio terminal 210 as soon as the latter changes from radio section 10 to radio section 20.

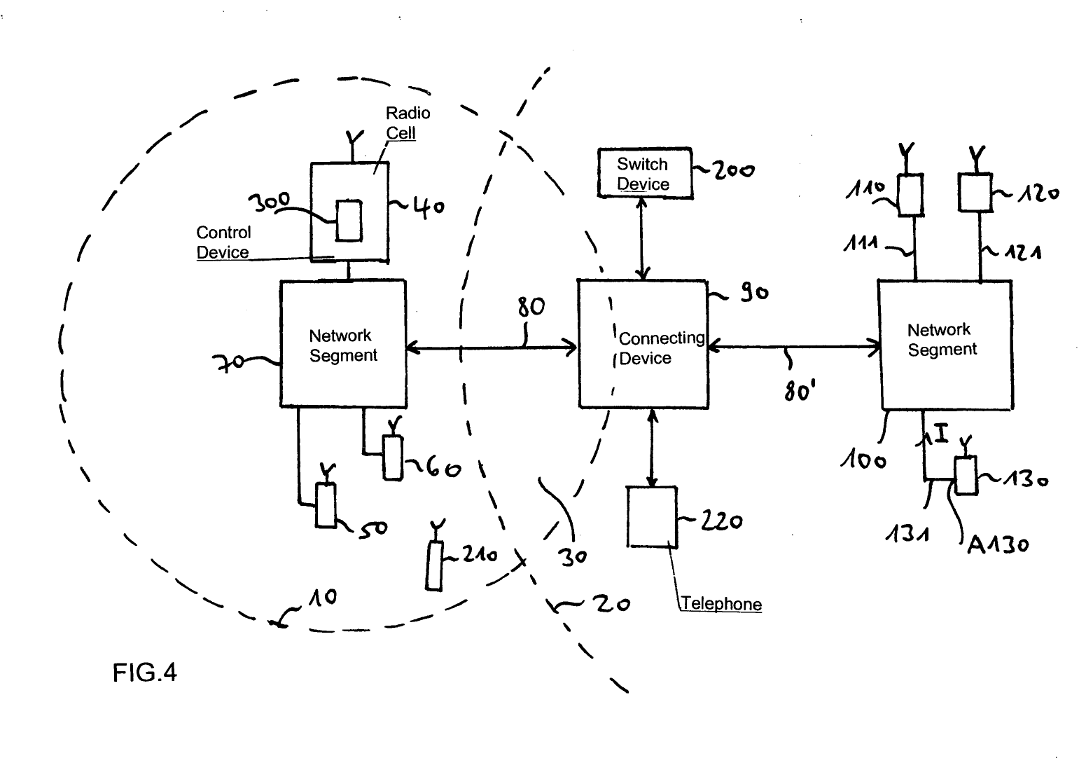

In the exemplary embodiment according to FIG. 4, the control device 300 is integrated within a radio network access device, for example the radio network access device 40 in this case. In this case, too, the operation of the control device 300 corresponds to the operation as has already been explained in conjunction with FIG. 1.

As can be seen in FIGS. 1 to 4, it is of no importance for the operation of the configuration whether the control device 300 is formed by a separate component or is integrated in another component, either in the switching device, in the radio network access devices or in other components, for example components of one of the two network segments 70 or 100.

In addition, it should be mentioned that the operation of the control device 300 can also be distributed over a number of different components as has already been discussed in conjunction with FIG. 1. Thus, the operation of the control device 300 can be implemented, for example, partially in the switching device 200 and partially in other components such as, for example, the radio network access devices or the components of the two network segments 70 or 100.

The operation of the control device 300 is preferably implemented by a DP program which is implemented in one or more components 40, 50, 60, 70, 90, 100, 110, 12, 130 or 200 or components of these components.

In a particularly preferred manner, the control device 300 will parameterize the transmission characteristics across radio sections in such a manner that all transmission paths are taken into consideration which can be accessed by the mobile radio terminal which has changed a radio section, newly enters a radio section or has newly switched on or registered in it. In this context, the control device 300 will preferably perform the parameterization in such a manner that data or voice transmissions can also take place via the transmission path with the lowest power (e.g. because of little bandwidth, large jitter, high packet losses) with a predetermined minimum quality standard (quality of service).

We claim:

1. A configuration, comprising:
at least two radio sections, each one of said radio sections having a line-connected network segment and at least one radio network access device connected in a line-connected manner to said network segment, said at least one radio network access device provided for connecting by radio to at least one mobile radio terminal;
a connecting device connected to said network segment of each of said at least two radio sections for connecting said two network segments with one another; and
a control device constructed such that, as soon as the mobile radio terminal changes from one of said radio sections to another one of said radio sections, said control device automatically reparameterizes transmission characteristics at least at one point or in one section of transmission paths available to the mobile radio terminal which has changed to a different one of said radio sections.

2. The configuration according to claim 1, wherein said control device is constructed such that, as soon as the mobile radio terminal changes from one of said radio sections to another one of said radio sections, said control device automatically performs a reparameterization of the transmission characteristics at least at one point or in one section of a connecting path between the mobile radio terminal which has changed to a different one of said radio sections, and said connecting device.

3. The configuration according to claim 1, wherein said two network segments of said at least two radio sections have different transmission characteristics.

4. The configuration according to claim 1, wherein said network segments of said at least two radio sections have identical transmission characteristics, and said connecting device has transmission characteristics differing from those of said two network segments.

5. The configuration according to claim 3, wherein said transmission characteristics differ with respect to at least one of bandwidths, packet delay times, packet loss rates and jitter.

6. The configuration according to claim 1, wherein said control device performs the reparameterization of the transmission characteristics such that a transmission quality predetermined for the mobile radio terminal which has changed to a different one of said radio sections is achieved.

7. The configuration according to claim 1, wherein said network segment of each of said two radio sections are in each case formed by a LAN network.

8. The configuration according to claim 1, wherein said control device performs the reparameterization of the transmission characteristics in that said control device reparameterizes at least one of the mobile radio terminal and said radio network access device to which the mobile radio terminal has changed.

9. The configuration according to claim 1, wherein:
said radio network access device is selected from the group consisting of WLAN access points and DECT base stations; and
the mobile radio terminal is selected from the group consisting of WLAN terminals and DECT terminals.

10. The configuration according to claim 4, wherein said transmission characteristics differ with respect to at least one of bandwidths, packet delay times, packet loss rates and jitter.

11. A method for operating the configuration according to claim 1, which comprises the steps of:
reparameterizing the transmission characteristics at least at the one point or in the one section of the transmission paths available to the mobile radio terminal when the mobile radio terminal changes from one of the radio sections to another one of the radio sections.

12. A configuration, comprising:
at least two radio sections each having a network segment and radio network access devices connected to said network segment in a line-connected manner, in each case at least one mobile radio terminal can be connected by radio to said radio network access devices, said network segment in each case being a LAN network having connecting lines connected to said radio network access devices;
a connecting device having individual connecting lines for connecting to said network segment of each of said at least two radio sections;
a telecommunication terminal connected to said connecting device; and
a control device constructed such that, as soon as the mobile radio terminal changes from one of said radio sections to another one of said radio sections, said control device automatically reparameterizes transmission characteristics at least at one point or in one section of transmission paths available to the mobile radio terminal which has changed to a different one of said radio sections, a connection between the mobile radio terminal and said telecommunication terminal being established before the change from one of said radio sections into another one of said radio sections by said LAN network of said previous radio section, said connecting line and said connecting device and, after a change of said radio sections, by said LAN network of said new radio section, said connecting line and said connecting device.
